(19) United States
(12) Patent Application Publication
(10) Pub. No.: US 2017/0344070 A1
(43) Pub. Date: Nov. 30, 2017

(54) TOUCH PANEL UNIT

(71) Applicant: FUJITSU COMPONENT LIMITED, Tokyo (JP)

(72) Inventors: Yayoi TOKUHARA, Tokyo (JP); Masahiro KANEKO, Tokyo (JP); Nobuo YATSU, Tokyo (JP); Kohei TAKAHASHI, Tokyo (JP); Ying LI, Tokyo (JP); Katsuaki KOSHIMURA, Tokyo (JP); Chuqi LIANG, Tokyo (JP); Miki KITAHARA, Tokyo (JP)

(21) Appl. No.: 15/537,934

(22) PCT Filed: Dec. 2, 2015
(86) PCT No.: PCT/JP2015/083881

§ 371 Date: Jun. 20, 2017

(30) Foreign Application Priority Data
Dec. 26, 2014 (JP) 2014-265724

(51) Int. Cl. G06F 1/16; G06F 3/044; G06F 3/045

(52) U.S. Cl. CPC G06F 1/1643; G06F 3/045; G06F 1/1626; G06F 3/044

(57) ABSTRACT

A touch panel unit attachable to an information terminal includes a bezel cover and a first touch panel disposed in the bezel cover. The touch panel unit is configured to be attached to the information terminal such that the first touch panel is positioned over a second touch panel of the information terminal. The first touch panel and the second touch panel employ different touch position detection techniques.

### TECHNICAL FIELD

An aspect of this disclosure is related to a touch panel unit.

### BACKGROUND ART

A touch panel is an input device that is provided on the front side of a display of a device such as a tablet terminal and enables a user to operate the device or input information via a user interface displayed on the display. Touch panels are used for various purposes.

Well-known types of touch panels include a resistive touch panel and a capacitive touch panel. A resistive touch panel includes an upper electrode substrate and a lower electrode substrate on which transparent conductive films are formed. The upper and lower electrode substrates are arranged to face each other. When a force is applied to the upper electrode substrate, the transparent conductive films contact each other so that a position at which the force is applied can be detected.

Resistive touch panels may be roughly categorized into two types: a 4-wire touch panel and a 5-wire touch panel. In the 4-wire touch panel, X-axis electrodes are provided on one of the upper and lower electrode substrates and Y-axis electrodes are provided on the other one of the upper and lower electrode substrates (see, for example, Patent Document 1). In the 5-wire touch panel, both X-axis electrodes and Y-axis electrodes are provided on the lower electrode substrate, and the upper electrode substrate functions as a probe for detecting a voltage (see, for example, Patent Document 2).

A capacitive touch panel is configured to detect an electric current that flows in a transparent electrode of the touch panel when, for example, a finger comes close to the touch panel and thereby detect a position touched by the finger.

Also, a disclosed touch panel has a structure formed by stacking a resistive touch panel and a capacitive touch panel having different characteristics as described above (see, for example, patent documents 3 and 4).

### RELATED-ART DOCUMENTS

### Patent Documents

[Patent Document 1] Japanese Laid-Open Patent Publication No. 2004-272722
[Patent Document 2] Japanese Laid-Open Patent Publication No. 2008-293129
[Patent Document 3] Japanese Utility Model Registration No. 3132106
[Patent Document 4] Japanese Utility Model Registration No. 3139196
[Patent Document 5] Japanese Laid-Open Patent Publication No. 2010-73071
[Patent document 6] Japanese Laid-Open Patent Publication No. H10-320119

### SUMMARY OF INVENTION

### Technical Problem

A capacitive touch panel detects a position based on capacitive coupling, and therefore can detect a position on the touch panel even when a user just touches the touch panel without pressing the touch panel. However, a capacitive touch panel cannot detect a position touched by an insulator. A resistive touch panel can detect a position on the touch panel regardless of the material of an object pressing the touch panel. However, because a resistive touch panel detects a position at which a transparent conductive film implementing an upper resistive film and a transparent conductive film implementing a lower resistive film contact each other, a user needs to press the touch panel with a given force.

Capacitive touch panels are mainly used for commercially-available tablet terminals. Therefore, those tablet terminals cannot detect a position touched by an insulator.

Also, because the touch panel, which is disclosed in Patent Documents 3 and 4 and formed by stacking a capacitive touch panel and a resistive touch panel, has a special structure, it is currently difficult to use the touch panel for a commercial tablet terminal.

For the above reasons, there is a demand for a technology that makes it possible to provide a commercial touch panel with both a capacitive touch panel and a resistive touch panel.

### Solution to Problem

In an aspect of this disclosure, there is provided a touch panel unit attachable to an information terminal. The touch panel unit includes a bezel cover and a first touch panel disposed in the bezel cover. The touch panel unit is configured to be attached to the information terminal such that the first touch panel is positioned over a second touch panel of the information terminal. The first touch panel and the second touch panel employ different touch position detection techniques.

### Advantageous Effects of Invention

An aspect of this disclosure provides a touch panel unit that makes it possible to provide a commercial touch panel with both a capacitive touch panel and a resistive touch panel.

### BRIEF DESCRIPTION OF DRAWINGS

FIG. 1A is a top view of a tablet terminal;

FIG. 1B is a side view of the tablet terminal;

FIG. 2 is a perspective view of a touch panel unit of a first embodiment;

FIG. 3 is a perspective view of the touch panel unit of the first embodiment and the tablet terminal;

FIG. 4 is a perspective view of the touch panel unit of the first embodiment and the tablet terminal;

FIG. 5 is a drawing illustrating a structure of a touch panel unit of a second embodiment;

FIG. 6 is a perspective view of the touch panel unit of the second embodiment and the tablet terminal;

FIG. 7 is a cross-sectional view of the touch panel unit of the second embodiment and the tablet terminal;

FIG. 8A is an enlarged view of a part of the touch panel unit and the tablet terminal of FIG. 7;

FIG. 8B is an enlarged view of a part of the touch panel unit and the tablet terminal of FIG. 7;

FIG. 9 is a drawing illustrating a touch panel unit according to a variation of the second embodiment;

FIG. 10 is a perspective view of a touch panel unit of a third embodiment and the tablet terminal;

FIG. 11 is a perspective view of the touch panel unit of the third embodiment and the tablet terminal;

FIG. 12 is a side view of the touch panel unit of the third embodiment and the tablet terminal;

FIG. 13 is a side view of the touch panel unit of the third embodiment and the tablet terminal;

FIG. 14 is a perspective view of a touch panel unit according to a variation of the third embodiment;

FIG. 15 is a side view of the touch panel unit according to the variation of the third embodiment;

FIG. 16 is an enlarged view of a part of the touch panel unit of FIG. 14;

FIG. 17 is a perspective view of the touch panel unit according to the variation of the third embodiment;

FIG. 18 is a side view of the touch panel unit according to the variation of the third embodiment;

FIG. 19 is an enlarged view of a part of the touch panel unit of FIG. 17;

FIG. 20 is a perspective view of a touch panel unit according to a variation of the third embodiment;

FIG. 21A is a top view of the touch panel unit according to the variation of the third embodiment;

FIG. 21B is a cross-sectional view taken along line 21A-21B of FIG. 21A;

FIG. 22 is a perspective view of a touch panel unit of a fourth embodiment;

FIG. 23 is an enlarged view of a part of the touch panel unit of FIG. 22;

FIG. 24 is a top view of the touch panel unit of the fourth embodiment and the tablet terminal;

FIG. 25 is a cross-sectional view taken along line 24A-24B of FIG. 24;

FIG. 26 is an enlarged view of a part of the touch panel unit and the tablet terminal of FIG. 25;

FIG. 27 is a cross-sectional view taken along line 24C-24D of FIG. 24;

FIG. 28 is a perspective view of a touch panel unit of a fifth embodiment;

FIG. 29 is a perspective view of the touch panel unit of the fifth embodiment and the tablet terminal;

FIG. 30 is a top view of the touch panel unit of the fifth embodiment and the tablet terminal;

FIG. 31 is a perspective view of a touch panel unit of a sixth embodiment;

FIG. 32 is a perspective view of the touch panel unit of the sixth embodiment and the tablet terminal;

FIG. 33 is a top view of the touch panel unit of the sixth embodiment and the tablet terminal;

FIG. 34 is a perspective view of a touch panel unit of a seventh embodiment;

FIG. 35 is a perspective view of the touch panel unit of the seventh embodiment;

FIG. 36 is a perspective view of the touch panel unit of the seventh embodiment and the tablet terminal;

FIG. 37 is a perspective view of the touch panel unit of the seventh embodiment and the tablet terminal;

FIG. 38A is a block diagram illustrating a configuration of a tablet terminal of an eighth embodiment;

FIG. 38B is a block diagram illustrating a configuration of a touch panel unit of the eighth embodiment;

FIG. 39 is a flowchart illustrating operations of a touch panel unit according to the eighth embodiment;

FIG. 40 is a drawing illustrating an example of a selection screen of the eighth embodiment; and

FIG. 41 is a flowchart illustrating operations of a touch panel unit according to a ninth embodiment.

### DESCRIPTION OF EMBODIMENTS

Embodiments of the present invention are described below with reference to the accompanying drawings. Below, the same reference number is assigned to the same component, and repeated descriptions of the same component are omitted.

### First Embodiment

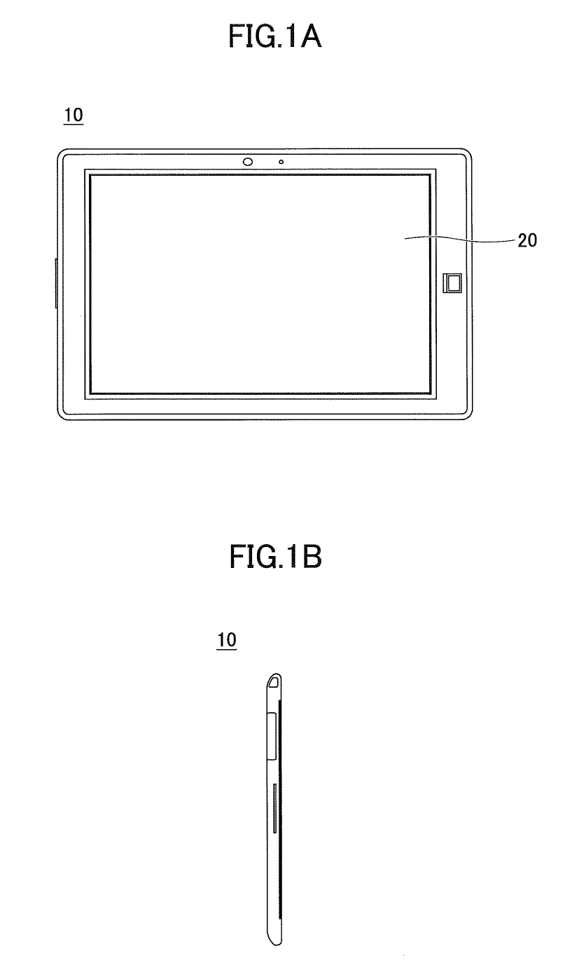

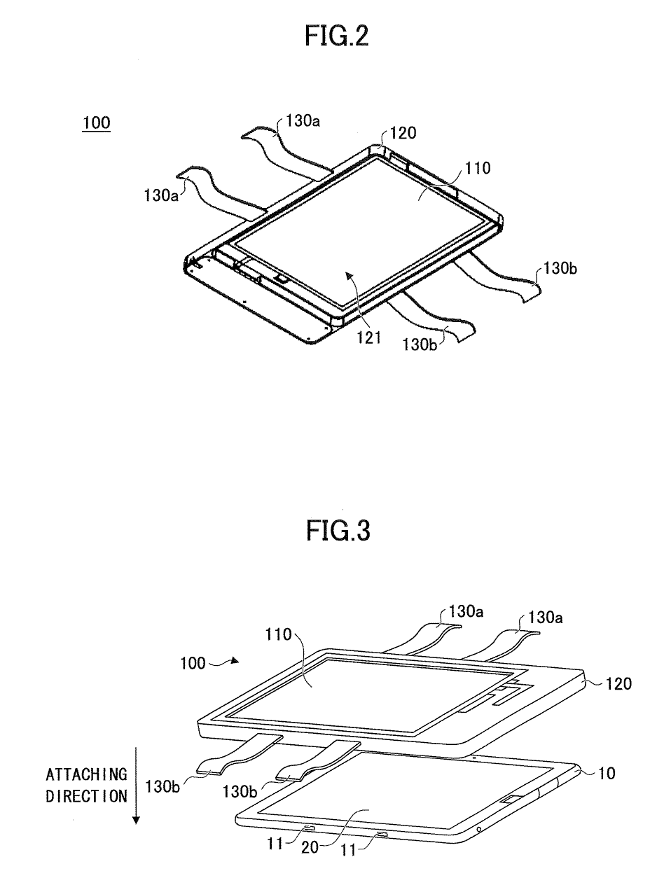

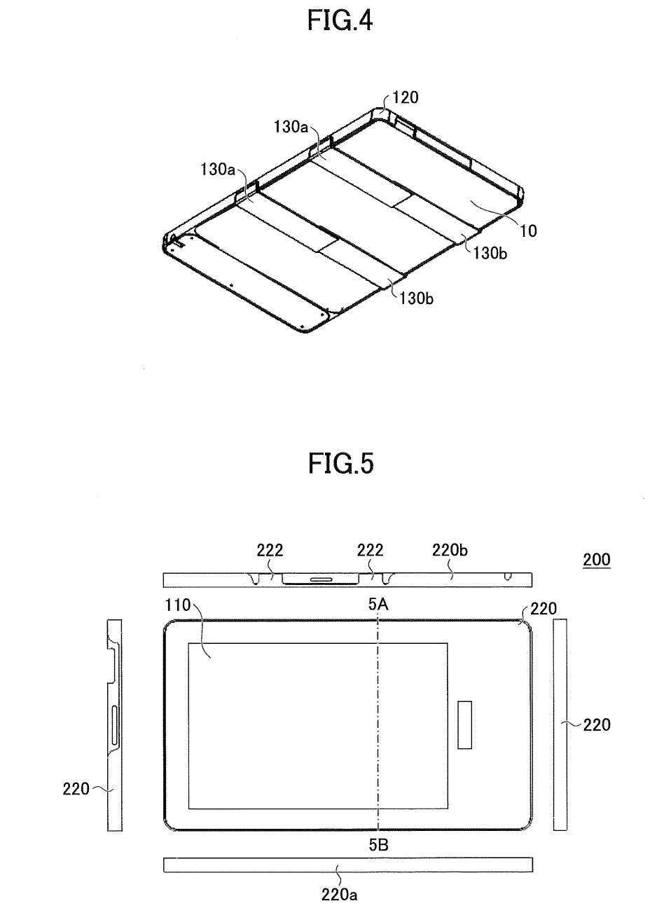

A touch panel unit according to a first embodiment is described with reference to FIGS. 1A through 4. FIG. 1A is a top view and FIG. 1B is a side view of a tablet terminal 10 to which a touch panel unit 100 of the first embodiment is attached. FIG. 2 is a perspective view of the touch panel unit 100 of the first embodiment. FIG. 3 is a perspective view of the tablet terminal 10 and the touch panel unit 100 before the touch panel unit 100 is attached to the tablet terminal 10. FIG. 4 is a perspective view of the tablet terminal 10 and the touch panel unit 100 attached together.

The touch panel unit 100 of the first embodiment includes a touch panel 110 and is to be attached to the tablet terminal 10 including a touch panel 20 illustrated in FIG. 1A. The touch panel 20 of the tablet terminal 10 is a capacitive touch panel that employs a capacitive touch position detection technique.

As illustrated by FIG. 2, the touch panel unit 100 of the first embodiment includes the touch panel 110, a bezel cover 120, and tying tapes 130a and 130b. A recess 121 for housing the tablet terminal 10 is formed in the bezel cover 120. The touch panel 110 is disposed in the middle of the bezel cover 120. As illustrated in FIG. 4, two tying tapes 130a and two tying tapes 130b are attached to the lateral sides of the bezel cover 120. The tying tapes 130a and 130b are implemented by, for example, hook-and-loop fasteners whose surfaces can be detachably attached to each other. The touch panel 110 is a resistive touch panel that employs a resistive touch position detection technique.

As illustrated by FIGS. 3 and 4, the touch panel unit 100 of the first embodiment is attached to the front side of the tablet terminal 10 where the touch panel 20 is located. Specifically, the front side of the tablet terminal 10 is placed in the recess 121 of the touch panel unit 100, and the tying tapes 130a and the tying tapes 130b are joined to each other on the back side of the tablet terminal 10 to attach the touch panel unit 100 to the tablet terminal 10.

In the first embodiment, it is assumed that the touch panel 20 of the tablet terminal 10 is a capacitive touch panel and the touch panel 110 of the touch panel unit 100 is a resistive touch panel. However, the touch panel 20 of the tablet terminal 10 may be a resistive touch panel and the touch panel 110 of the touch panel unit 100 may be a capacitive touch panel. That is, it is possible to enable one tablet terminal 10 to use the touch panel 20 of the tablet terminal 10 and the touch panel 110 of the touch panel unit 100 as long as the touch panel 20 and the touch panel 110 employ different detection techniques.

### Second Embodiment

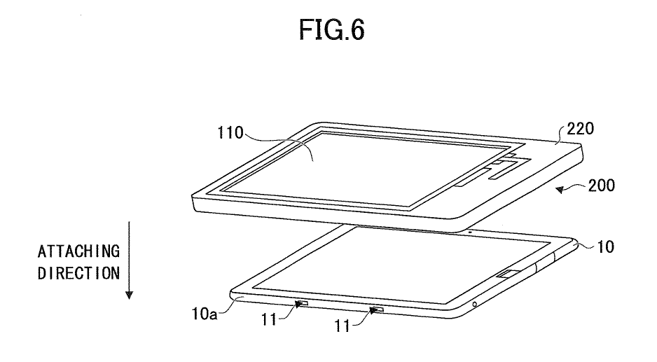

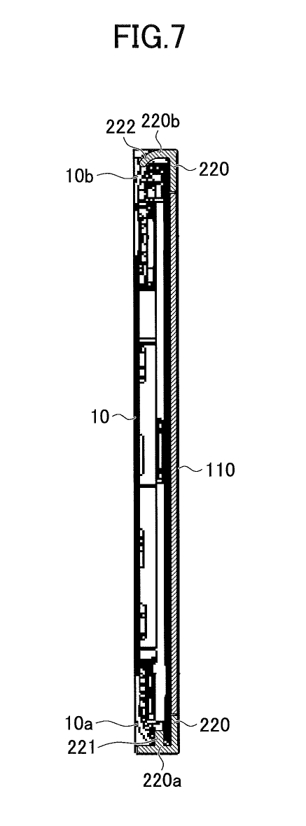

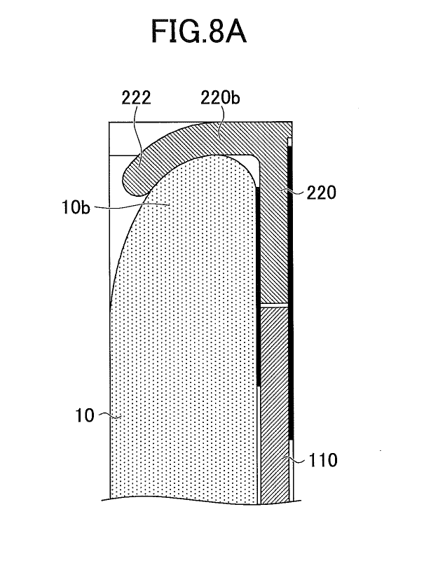

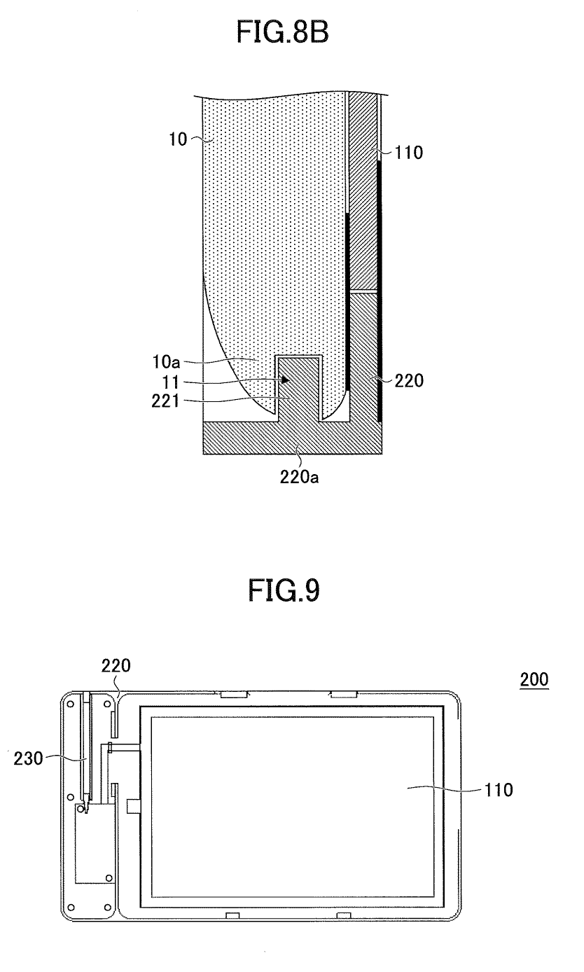

A touch panel unit according to a second embodiment is described with reference to FIGS. 5 through 8B. FIG. 5 is an orthographic drawing of a touch panel unit 200 of the second embodiment. FIG. 6 is a perspective view of the tablet terminal 10 and the touch panel unit 200 before the touch panel unit 200 is attached to the tablet terminal 10. FIG. 7 is a cross-sectional view of the tablet terminal 10 and the touch panel unit 200 attached together, taken along a dashed-dotted line 5A-5B of FIG. 5. FIGS. 8A and 8B are enlarged views of parts of FIG. 7.

The touch panel unit 200 of the second embodiment includes a touch panel 110 and a bezel cover 220. A recess for housing the tablet terminal 10 is formed in the bezel cover 220. The touch panel 110 is disposed in the middle of the bezel cover 220. In the second embodiment, attachment holes 11 are formed in a first lateral side 10a that is one of the longitudinal sides of the tablet terminal 10. Protrusions 221 to be inserted into the attachment holes 11 in the first lateral side 10a of the tablet terminal 10 are formed on the inner surface of a first side wall 220a of the bezel cover 220. A second side wall 220b of the bezel cover 220, which faces the first side wall 220a where the protrusions 221 are formed, is bent inward to form a lock 222.

In the second embodiment, the protrusions 221 formed on the inner surface of the first side wall 220a of the bezel cover 220 are inserted into the attachment holes 11 formed in the first lateral side 10a of the tablet terminal 10, and then a second lateral side 10b of the tablet terminal 10 is placed inside of the lock 222 formed by the second side wall 220b of the bezel cover 220 to attach the touch panel unit 200 to the tablet terminal 10.

Also, according to a variation of the second embodiment, as illustrated by FIG. 9, the bezel cover 220 of the touch panel unit 200 may be configured to house an operation pen 230 used to operate the touch panel 110.

### Third Embodiment

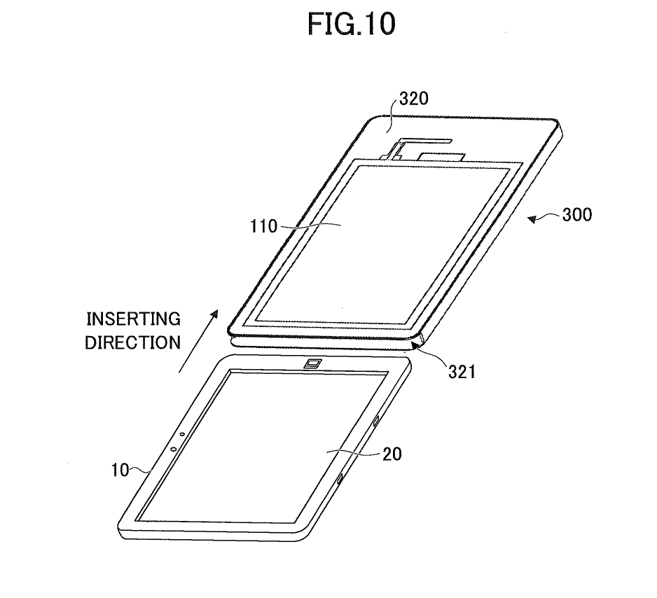

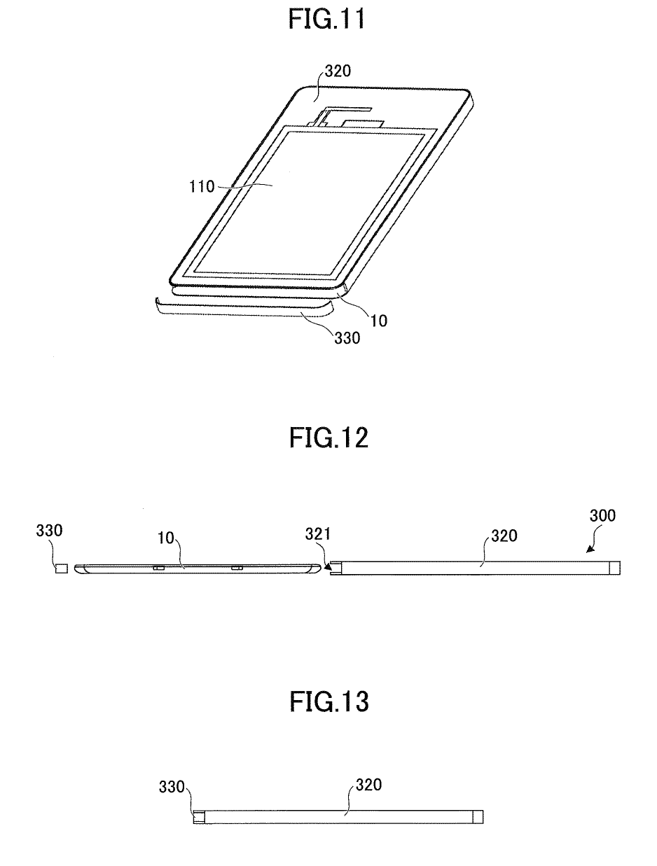

Next, a touch panel unit according to a third embodiment is described with reference to FIGS. 10 through 12. FIG. 10 is a perspective view of a touch panel unit 300 of the third embodiment and the tablet terminal 10 before being inserted into the touch panel unit 300. FIG. 11 is a perspective view of the touch panel unit 300 and the tablet terminal 10 inserted into the touch panel unit 300. FIG. 12 is a side view of the touch panel unit 300 and the tablet terminal 10 before being inserted into the touch panel unit 300. FIG. 13 is a side view of the touch panel unit 300 into which the tablet terminal 10 is inserted and a lid 330 is closed.

The touch panel unit 300 of the third embodiment includes a touch panel 110, a bezel cover 320, and the lid 330. The bezel cover 320 is formed in a box shape to house the tablet terminal 10, and includes an opening 321 through which the tablet terminal 10 is inserted. The tablet terminal 10 is inserted through the opening 321 into the bezel cover 320 such that a side of the tablet terminal 10, on which the touch panel 20 is provided, faces the touch panel 110 of the touch panel unit 300, and then the opening 321 is closed with the lid 330. The lid 330 may be formed of, for example, a metal, a waterproof tape, or rubber. When the lid 330 is formed of a waterproof tape or rubber, the lid 330 can seal the bezel cover 320, and the touch panel unit 300 has a waterproof structure.

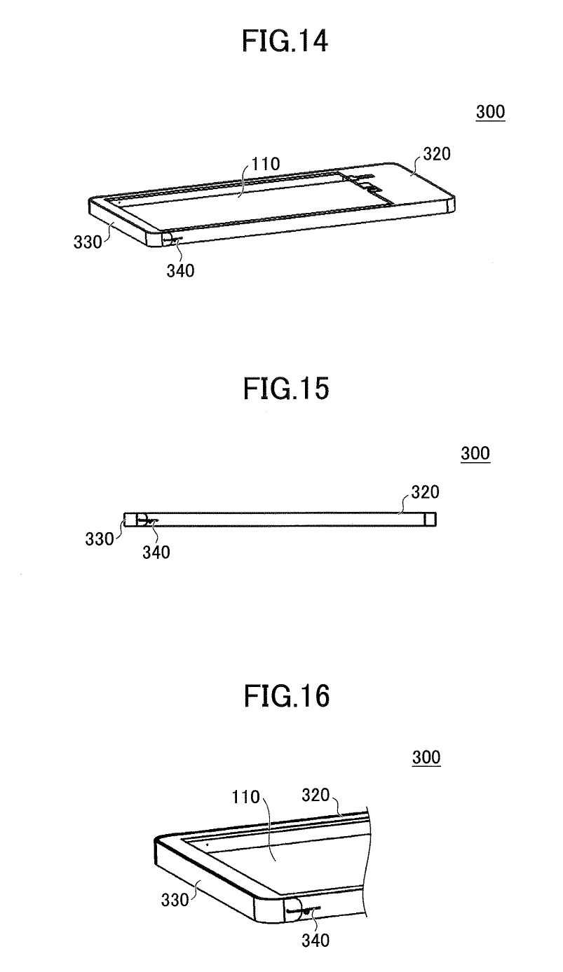

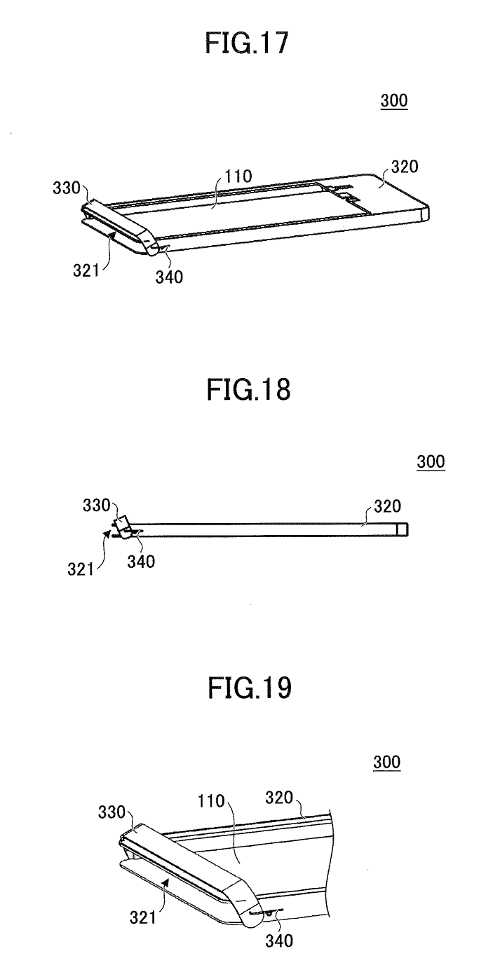

Also, according to a variation of the third embodiment, as illustrated by FIGS. 14 through 19, the lid 330 may be connected to the bezel cover 340 via a spring 340. FIG. 14 is a perspective view and FIG. 15 is a side view of the touch panel unit 300 in a state where the lid 330 connected via the spring 340 to the bezel cover 320 is closed. FIG. 16 is an enlarged view of a part of FIG. 14. FIG. 17 is a perspective view and FIG. 18 is a side view of the touch panel unit 300 in a state where the lid 330 is open. FIG. 19 is an enlarged view of a part of FIG. 17.

With this configuration, the lid 330 connected via the spring 340 to the bezel cover 320 is opened to insert the tablet terminal 10 through the opening 321 into the bezel cover 320, and the lid is closed to enclose the tablet terminal 10 in the touch panel unit 300.

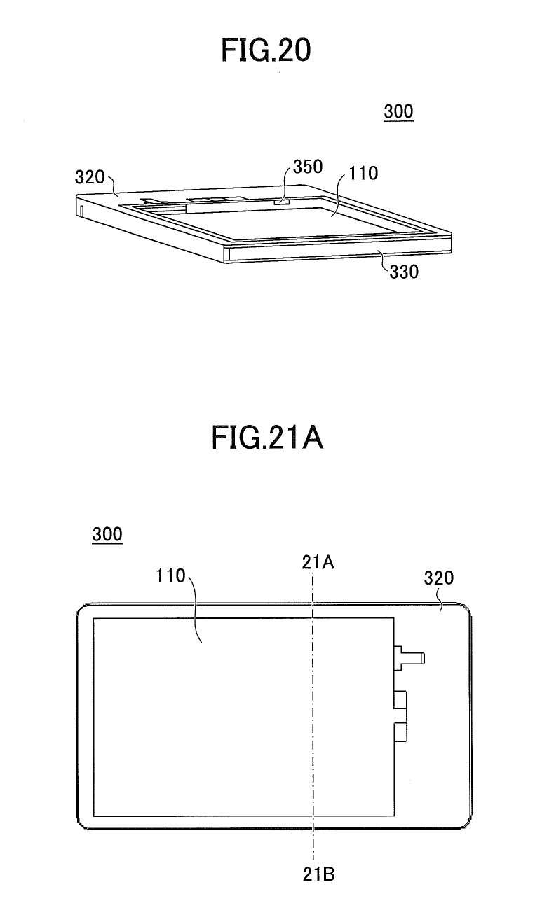

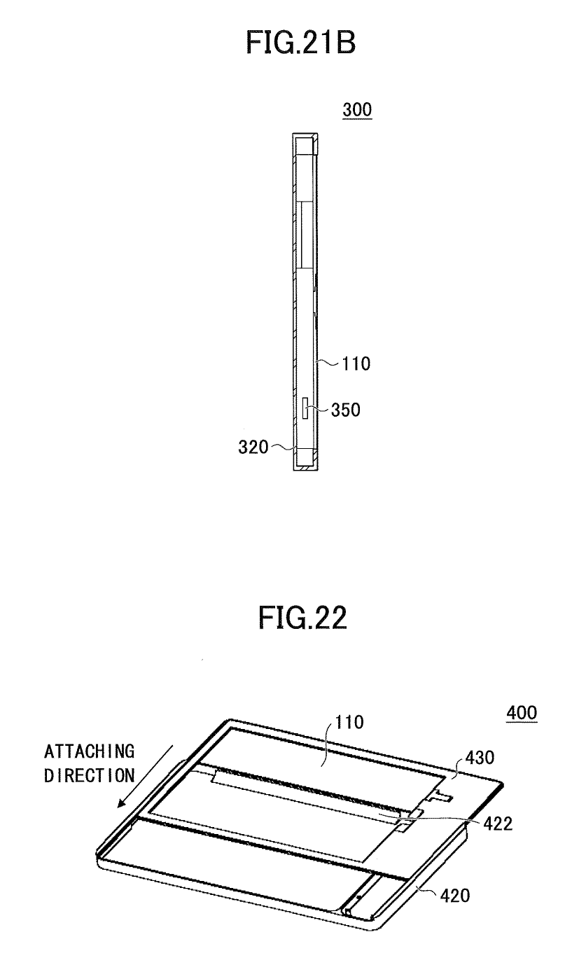

According to another variation of the third embodiment, as illustrated by FIGS. 20, 21A, and 21B, a connector 350 to be connected with a connector (not shown) of the tablet terminal 10 may be provided inside of the bezel cover 320. FIG. 20 is a perspective view and FIG. 21A is a top view of the touch panel unit 300 including the connector 350 disposed inside of the bezel cover 320. FIG. 21B is a cross-sectional view of the touch panel unit 300 taken along a dashed-dotted line 21A-21B of FIG. 21A.

### Fourth Embodiment

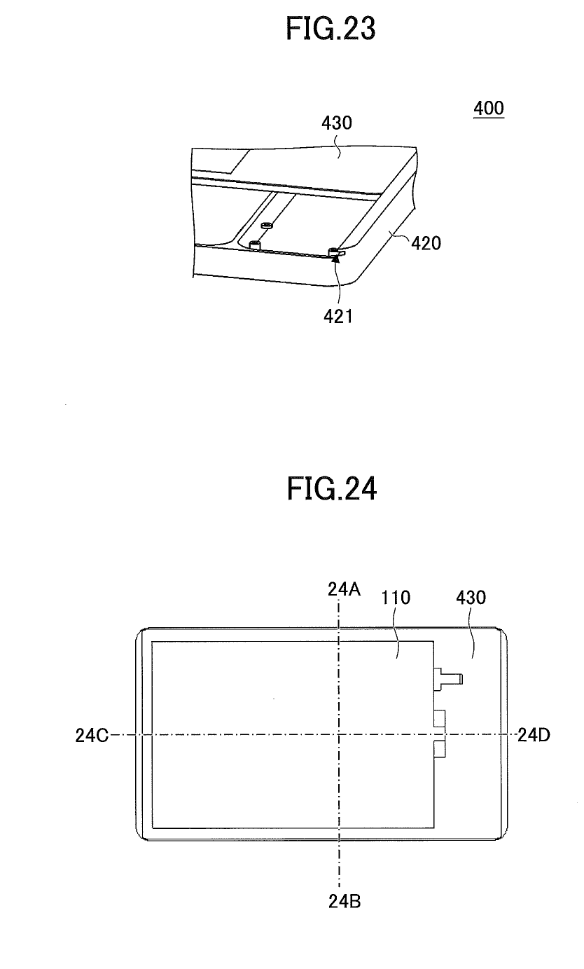

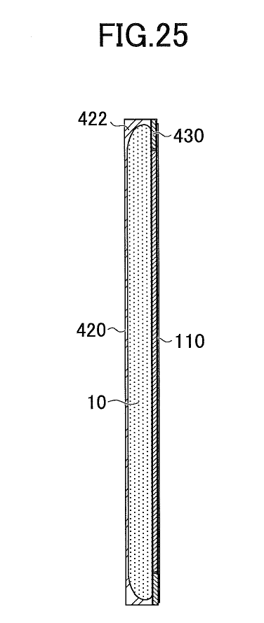

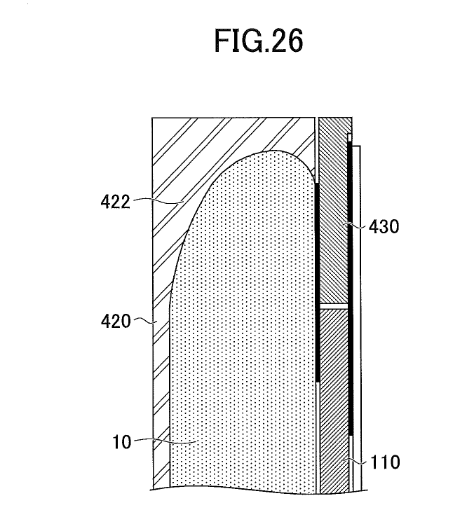

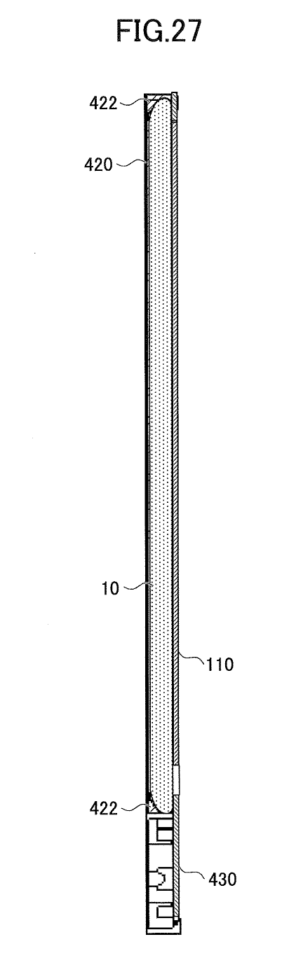

Next, a touch panel unit according to a fourth embodiment is described with reference to FIGS. 22 through 27. FIG. 22 is a perspective view of a touch panel unit 400 of the fourth embodiment. FIG. 23 is an enlarged view of a part of FIG. 22. FIG. 24 is a top view of the touch panel unit 400 of the fourth embodiment in which the tablet terminal 10 is placed. FIG. 25 is a cross-sectional view taken along a dashed-dotted line 24A-24B of FIG. 24. FIG. 26 is an enlarged view of a part of FIG. 25. FIG. 27 is a cross-sectional view taken along a dashed-dotted line 24C-24D of FIG. 24.

The touch panel unit 400 of the fourth embodiment includes a touch panel 110, a housing 420, and a bezel cover 430. The touch panel 110 is disposed in the bezel cover 430. The housing 420 is formed in an open-box shape to house the tablet terminal 10. Grooves 421 are formed in the inner side surfaces of the housing 420 to slidably hold the bezel cover 430. A fixing part 422 having a shape corresponding to the outer shape of the tablet terminal 10 is formed inside of the open-box-shaped housing 420. The position of the tablet terminal placed in the open-box-shaped housing 420 is determined by the fixing part 422, and therefore the tablet terminal 10 can be placed in an appropriate position. In this state, the bezel cover 430 is inserted into and slid along the grooves 421 in the inner side surfaces of the housing 420 and is thereby closed to enclose the tablet terminal 10 in the touch panel unit 400.

### Fifth Embodiment

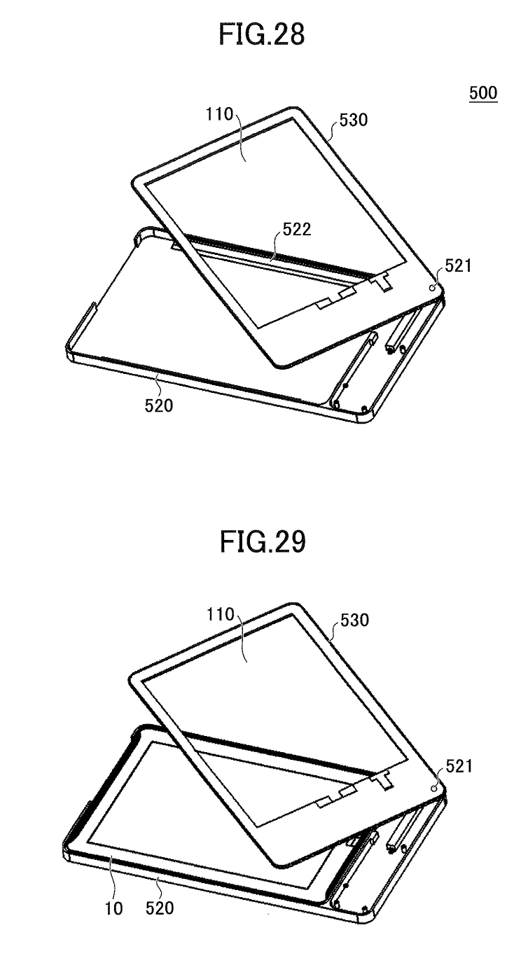

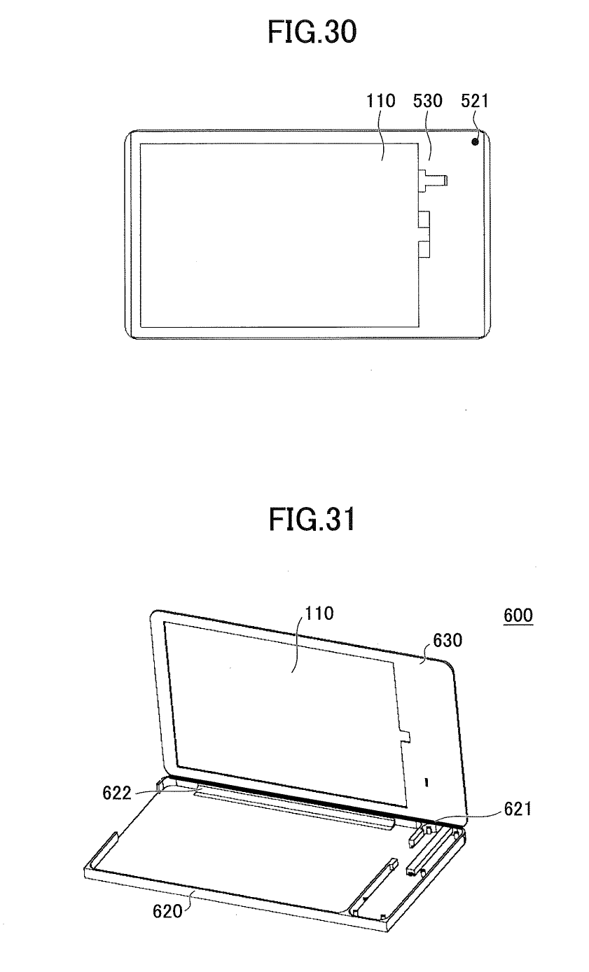

Next, a touch panel unit according to a fifth embodiment is described with reference to FIGS. 28 through 30. FIG. 28 is a perspective view of a touch panel unit 500 of the fifth embodiment. FIG. 29 is a perspective view of the touch panel unit 500 in which the tablet terminal 10 is placed and whose bezel cover 530 is partially open. FIG. 30 is a top view of the touch panel unit 500 in which the tablet terminal 10 is placed.

The touch panel unit 500 of the fifth embodiment includes a touch panel 110, a housing 520, and the bezel cover 530. The touch panel 110 is disposed in the bezel cover 530. The housing 520 is formed in an open-box shape to house the tablet terminal 10. The bezel cover 530 is connected to a corner of the housing 520 and is rotatable around a shaft 521.

A fixing part 522 having a shape corresponding to the outer shape of the tablet terminal 10 is formed inside of the open-box-shaped housing 520. The tablet terminal 10 is guided by the fixing part 522 and is placed in an appropriate position in the open-box-shaped housing 520. With the tablet terminal 10 placed in the housing 520, the bezel cover 530 is rotated around the shaft 521 and is closed as illustrated by FIG. 30 to enclose the tablet terminal 10 in the touch panel unit 500.

### Sixth Embodiment

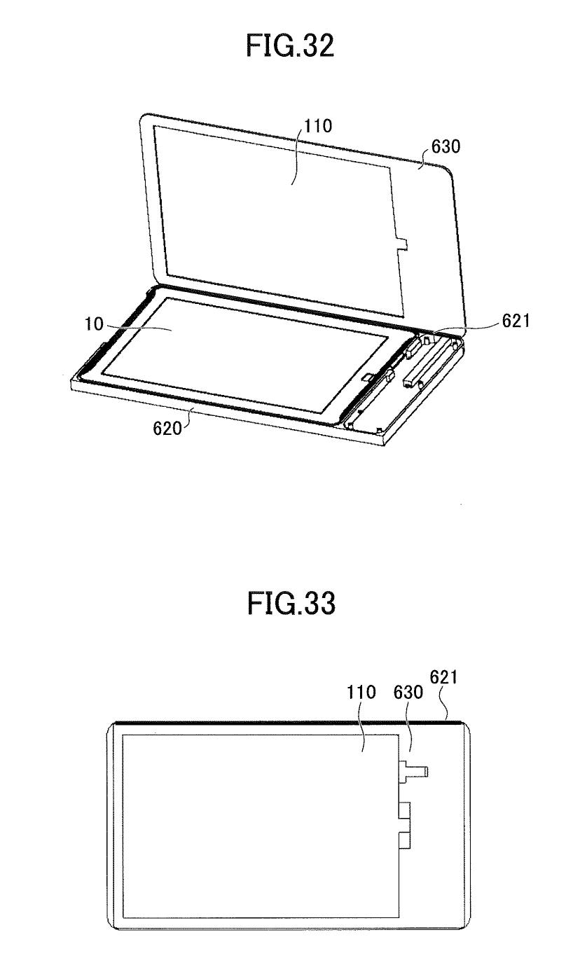

Next, a touch panel unit according to a sixth embodiment is described with reference to FIGS. 31 through 33. FIG. 31 is a perspective view of a touch panel unit 600 of the sixth embodiment. FIG. 32 is a perspective view of the touch panel unit 600 in which the tablet terminal 10 is placed and whose bezel cover 630 is open. FIG. 33 is a top view of the touch panel unit 600 in which the tablet terminal 10 is placed.

The touch panel unit 600 of the sixth embodiment includes a touch panel 110, a housing 620, and the bezel cover 630. The touch panel 110 is disposed in the bezel cover 630. The housing 620 is formed in an open-box shape to house the tablet terminal 10. The bezel cover 630 is connected to the housing 620 and can be opened and closed around a shaft 621 extending along a side edge of the housing 620.

A fixing part 622 having a shape corresponding to the outer shape of the tablet terminal 10 is formed inside of the open-box-shaped housing 620. The tablet terminal 10 is guided by the fixing part 622 and is placed in an appropriate position in the open-box-shaped housing 620. In this state, the bezel cover 630 is closed around the shaft 621 as illustrated by FIG. 33 to enclose the tablet terminal 10 in the touch panel unit 600.

### Seventh Embodiment

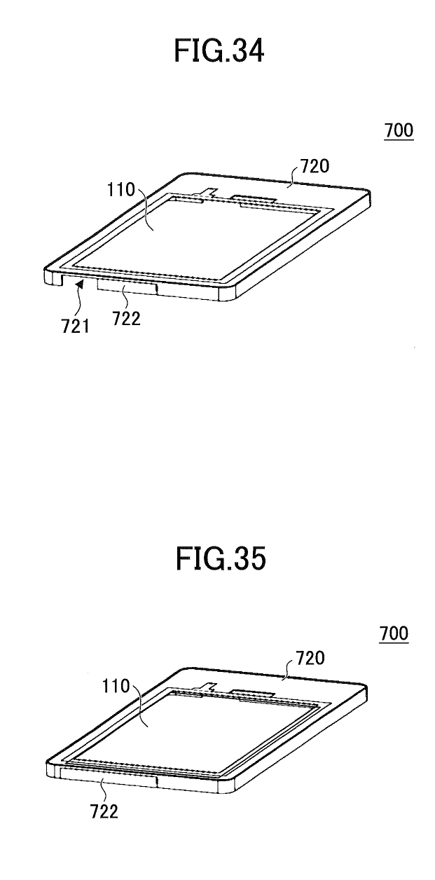

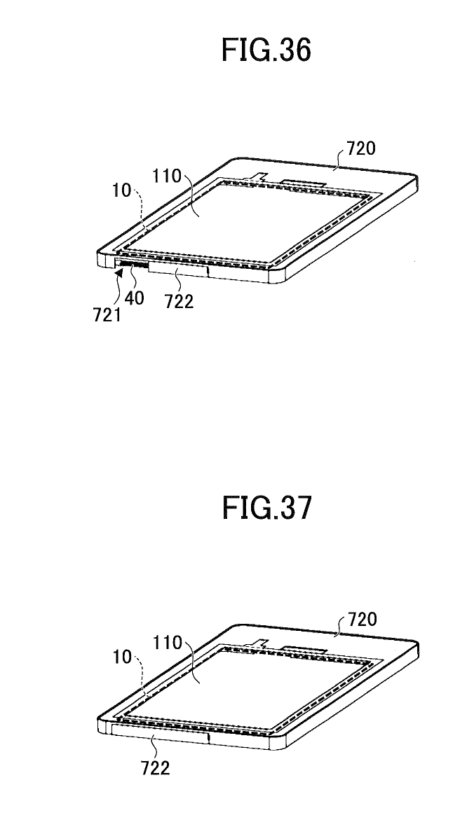

Next, a touch panel unit according to a seventh embodiment is described with reference to FIGS. 34 through 37. FIGS. 34 and 35 are perspective views of a touch panel unit 700 of the seventh embodiment. FIG. illustrates a state where a sliding cover 722 of a bezel cover 720 is open, and FIG. 35 illustrates a state where the sliding cover 722 is closed. FIGS. 36 and 37 are perspective views of the touch panel unit 700 in which the tablet terminal 10 is placed. FIG. 36 illustrates a state where the sliding cover 722 of the bezel cover 720 is open, and FIG. 37 illustrates a state where the sliding cover 722 is closed.

The touch panel unit 700 of the seventh embodiment includes a touch panel 110, the bezel cover 720, and the sliding cover 722. The touch panel 110 is disposed in the bezel cover 720. The bezel cover 720 is configured to house the tablet terminal 10. An opening 721 is formed in a lateral side of the bezel cover 720 at a position corresponding to the position of a connecting terminal 40 of the tablet terminal 10. The sliding cover 722 is provided to open and close the opening 721.

As illustrated by FIG. 36, the connecting terminal 40 of the tablet terminal 10 can be exposed in the opening 721 by sliding and opening the sliding cover 722. Even when the tablet terminal 10 is placed in the touch panel unit 700, this configuration makes it possible to connect the connecting terminal 40 of the tablet terminal 10 to a connector (not shown) outside of the touch panel unit 700.

### Eighth Embodiment

Next, an eighth embodiment is described. According to the eighth embodiment, a touch panel unit is attached to a tablet terminal, a connector (e.g., the connector 350 in FIGS. 20 and 21B) of the touch panel unit is connected to a connector of the tablet terminal, and touch panels to be used are manually switched.

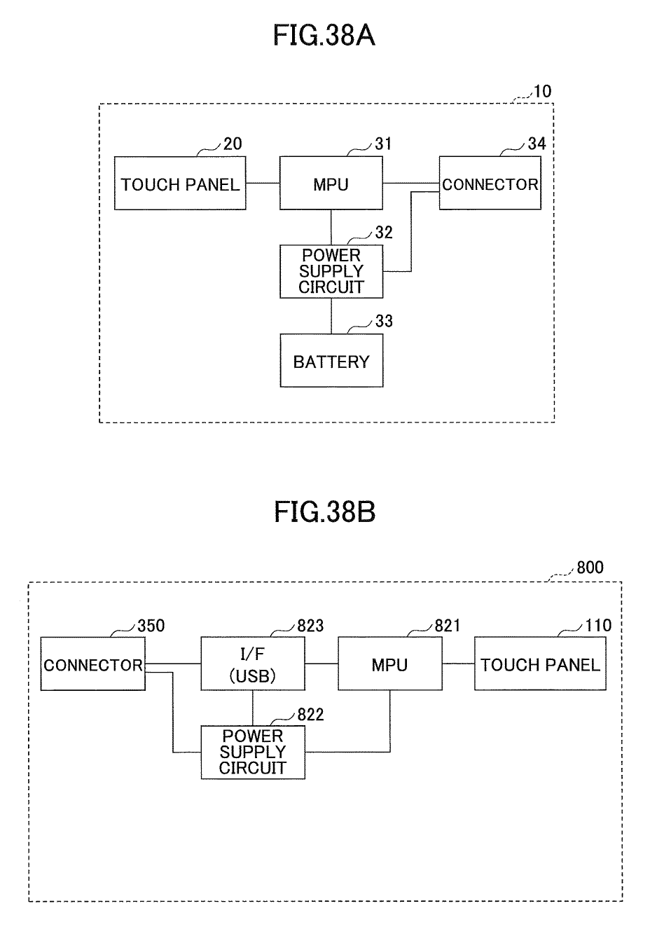

As illustrated by FIG. 38A, the tablet terminal 10 includes a capacitive touch panel 20, a micro-processing unit (MPU) 31, a power supply circuit 32, a battery 33, and a connector 34. As illustrated by FIG. 38B, a touch panel unit 800 includes a resistive touch panel 110, an MPU 821, a power supply circuit 822, an interface (I/F) 823, and a connector 350. In the eighth embodiment, the connector 34 of the tablet terminal 10 and the connector 350 of the touch panel unit 800 are connected to each other by attaching the touch panel unit 800 to the tablet terminal 10. For example, when the connectors 34 and 350 are connected to each other, power may be supplied from the battery 33 of the tablet terminal 10 to the touch panel unit 800. Alternatively, the touch panel unit 800 may include a battery, and power may be supplied from the touch panel unit 800 to the tablet terminal 10.

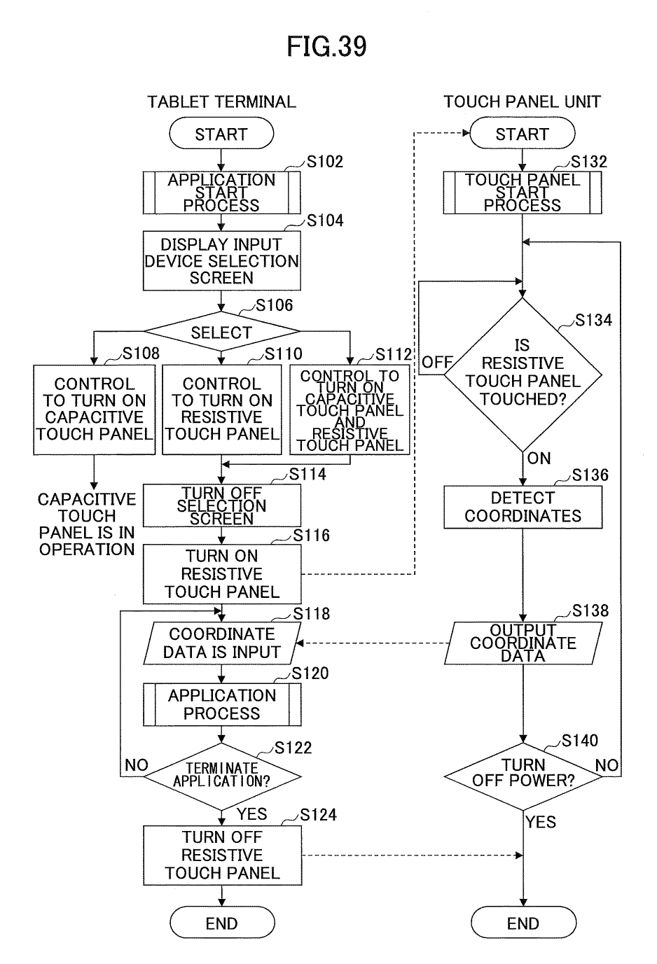

A method of manually switching touch panels to be used is described with reference to FIG. 39.

First, at step 102 (S102), the tablet terminal performs an application start process to start an application. In other words, the tablet terminal 10 is started.

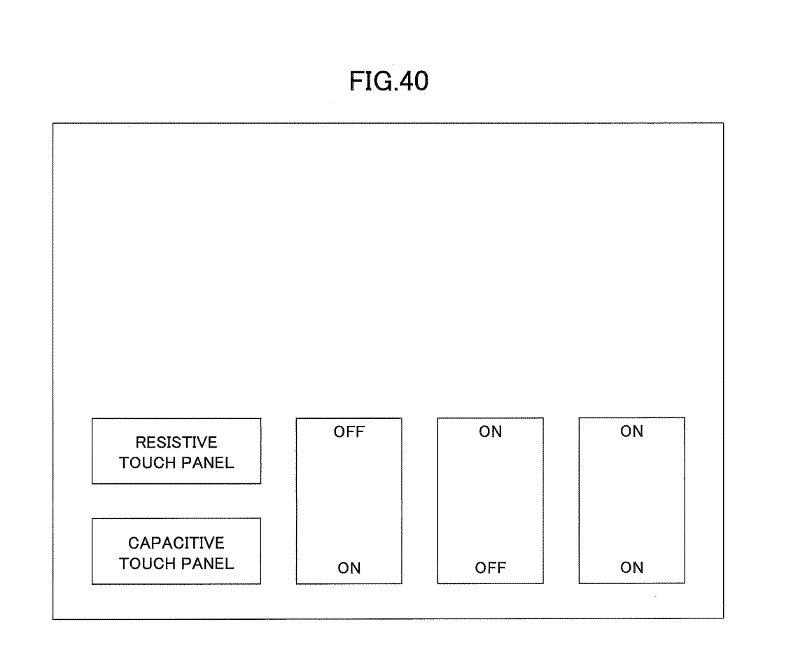

Next, at step 104 (S104), the tablet terminal displays an input device selection screen for selecting touch panels on a display of the tablet terminal 10. More specifically, the tablet terminal 10 displays a selection screen as illustrated by FIG. 40 to allow an operator to select the capacitive touch panel 20, the resistive touch panel 110, or both of the capacitive touch panel 20 and the resistive touch panel 110.

Next, at step 106 (S106), the operator touches the selection screen displayed on the tablet terminal 10 to select the capacitive touch panel 106, the resistive touch panel 10, or both of the capacitive touch panel 20 and the resistive touch panel 110. When the capacitive touch panel 20 is selected, the tablet terminal 10 proceeds to step 108. When the resistive touch panel 110 is selected, the tablet terminal 10 proceeds to step 110. When both of the capacitive touch panel 20 and the resistive touch panel 110 are selected, the tablet terminal 10 proceeds to step 112.

At step 108 (S108), after the capacitive touch panel 20 is selected and the selection screen disappears, the tablet terminal 10 maintains the ON state of the capacitive touch panel 20. That is, the operator can operate the tablet terminal 10 in a usual manner even after step 108.

At step 110 (S110), the tablet terminal 10 starts a control process to use the resistive touch panel 110. More specifically, the tablet terminal 10 turns off the capacitive touch panel 20 and proceeds to step 114 to turn on the resistive touch panel 110.

At step 112 (S112), the tablet terminal 10 starts a control process to use both of the capacitive touch panel 20 and the resistive touch panel 110. More specifically, the tablet terminal 10 proceeds to step 114 to maintain the ON state of the capacitive touch panel 20 and turn on the resistive touch panel 110.

At step 114 (S114), the tablet terminal 10 clears the selection screen.

Next, at step 116 (S116), the tablet terminal 10 turns on the resistive touch panel 110. At this step, the tablet terminal 10 sends a command to the touch panel unit 800. In response to the command, at step 132 (S132), the touch panel unit 800 performs a touch panel start process to turn on the resistive touch panel 110.

Next, at step S134 (S134), the touch panel unit 800 determines whether the resistive touch panel 110 has been touched. When it is determined that the resistive touch panel 110 has been touched, the touch panel unit 800 proceeds to step 136. When it is determined that the resistive touch panel 110 has not been touched, the touch panel unit 800 repeats step 134.

When it is determined at step 134 that the resistive touch panel 110 has been touched, the touch panel unit 800 proceeds to step 136 (S136) to detect coordinates of a touched position on the resistive touch panel 110.

Next, at step 138 (S138), the touch panel unit 800 outputs coordinate data indicating the detected coordinates of the touched position on the resistive touch panel 110 to the tablet terminal 10. Then, at step 140 (S140), the touch panel unit 800 determines whether to turn off power. When it is determined to turn off power according to an operation performed by the operator, the touch panel unit 800 terminates the process. When it is determined to not turn off power, the touch panel unit 800 returns to step 134.

When the coordinate data indicating the coordinates of the touched position detected by the resistive touch panel 110 is output at step 138 from the touch panel unit 800 to the tablet terminal 10, the coordinate data is input to the tablet terminal 10 at step 118 (S118).

At step 120 (S120), the tablet terminal 10 performs an application process based on the input coordinate data.

Next, at step 122 (S122), the tablet terminal 10 determines whether to terminate the application. When it is determined to terminate the application, the tablet terminal 10 proceeds to step 124. When it is determined to not terminate the application, the tablet terminal 10 returns to step 118.

When it is determined at step 122 to terminate the application, the tablet terminal 10 at step 124 (S124) performs a control process to turn off the resistive touch panel 110, and sends a command to the touch panel unit 800. In response to the command, the power of the touch panel unit 800 is turned off.

When both of the resistive touch panel 110 and the capacitive touch panel 20 are selected at step 106, step 114 and subsequent steps are performed and similarly to the case of step 108, the ON state of the capacitive touch panel 20 is maintained even after step 112. When a touch on the capacitive touch panel 20 is detected, the tablet terminal 10 performs a process corresponding to the detection result.

### Ninth Embodiment

Next, a ninth embodiment is described. According to the ninth embodiment, when the tablet terminal 10 is attached to the touch panel unit 800 and a connector (e.g., the connector 350 in FIGS. 20 and 21B) of the touch panel unit 800 is connected to a connector of the tablet terminal 10, an active touch panel is automatically switched from the capacitive touch panel 20 of the tablet terminal 10 to the resistive touch panel 110 of the touch panel unit 800. The tablet terminal 10 and the touch panel unit 800 are the same as those used in the eighth embodiment.

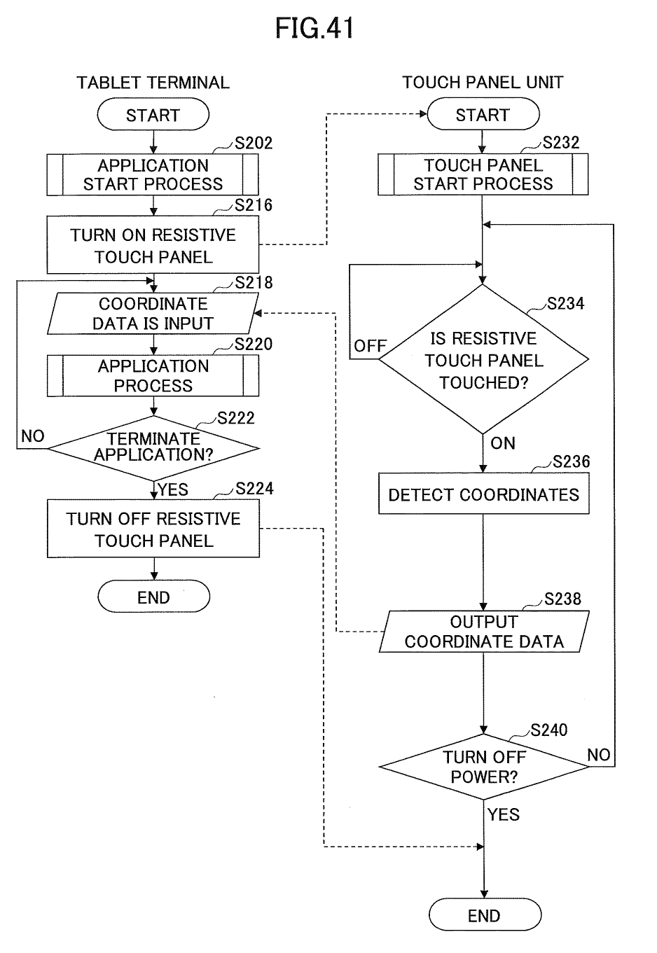

A method of switching touch panels to be used is described with reference to FIG. 41.

First, at step 202 (S202), the tablet terminal performs an application start process to start an application. In other words, the tablet terminal 10 is started.

Next, when the touch panel unit 800 is attached to the tablet terminal 10, the tablet terminal 10 performs, at step 216 (S216), a control process to turn on the resistive touch panel 110. At step 232 (S232), in response to a command from the tablet terminal 10, the touch panel unit 800 performs a touch panel start process to turn on the resistive touch panel 110. Step 216 is performed when the tablet terminal 10 detects that the connector 350 of the touch panel unit 800 is connected to the connector 34 of the tablet terminal 10.

Next, at step S234 (S234), the touch panel unit 800 determines whether the resistive touch panel 110 has been touched. When it is determined that the resistive touch panel 110 has been touched, the touch panel unit 800 proceeds to step 236. When it is determined that the resistive touch panel 110 has not been touched, the touch panel unit 800 repeats step 234.

When it is determined at step 234 that the resistive touch panel 110 has been touched, the touch panel unit 800 proceeds to step 236 (S236) to detect coordinates of a touched position on the resistive touch panel 110.

Next, at step 238 (S238), the touch panel unit 800 outputs coordinate data indicating the detected coordinates of the touched position on the resistive touch panel 110 to the tablet terminal 10. Then, at step 240 (S240), the touch panel unit 800 determines whether to turn off power. When it is determined to turn off power, the touch panel unit 800 terminates the process. When it is determined to not turn off power, the touch panel unit 800 returns to step 234.

When the coordinate data indicating the coordinates of the touched position detected by the resistive touch panel 110 is output at step 238 from the touch panel unit 800 to the tablet terminal 10, the coordinate data is input to the tablet terminal 10 at step 218 (S218).

At step 220 (S220), the tablet terminal 10 performs an application process based on the input coordinate data.

Next, at step 222 (S222), the tablet terminal 10 determines whether to terminate the application. When it is determined to terminate the application, the tablet terminal 10 proceeds to step 224. When it is determined to not terminate the application, the tablet terminal 10 returns to step 218.

When it is determined at step 222 to terminate the application, the tablet terminal 10 at step 224 (S224) performs a control process to turn off the resistive touch panel 110, and sends a command to the touch panel unit 800. In response to the command, the power of the touch panel unit 800 is turned off.

The bezel cover and the housing of the touch panel unit may be formed of, for example, a resin material, a metal, or rubber. The touch panel unit and the tablet terminal 10 may be configured to wirelessly communicate with each other.

Embodiments of the present invention are described above. However, the present invention is not limited to the specifically disclosed embodiment, and variations and modifications may be made without departing from the scope of the present invention.

For example, touch panel units of the above embodiments may also be used for information terminals, such as a smartphone, other than a tablet terminal.

The present application is based on and claims the benefit of priority of Japanese Patent Application No. 2014-265724 filed on Dec. 26, 2014, the entire contents of which are hereby incorporated herein by reference.

### EXPLANATION OF REFERENCE NUMERALS

10 Tablet terminal

20 Touch panel

100 Touch panel unit

110 Touch panel

120 Bezel cover

130a Tying tape

130b Tying tape

1. A touch panel unit attachable to an information terminal, the touch panel unit comprising:
a bezel cover; and
a first touch panel disposed in the bezel cover, wherein
the touch panel unit is configured to be attached to the information terminal such that the first touch panel is positioned over a second touch panel of the information terminal; and
the first touch panel and the second touch panel employ different touch position detection techniques.

2. The touch panel unit as claimed in claim 1, wherein one of the first touch panel and the second touch panel is a resistive touch panel and another one of the first touch panel and the second touch panel is a capacitive touch panel.

3. The touch panel unit as claimed in claim 1, wherein
the bezel cover includes a first fastener and a second fastener; and
the touch, panel unit is configured to be attached to the information terminal by joining an end of the first fastener to an end of the second fastener on a first surface of the information terminal that is opposite a second surface of the information terminal where the second touch panel is located.

4. The touch panel unit as claimed in claim 1, wherein
the bezel cover has a shape to cover a surface of the information terminal where the second touch panel is located;
the bezel cover includes a protrusion formed on an inner surface of a first side wall of the bezel cover, the protrusion being configured to be inserted into an attachment hole formed in a first lateral side of the information terminal; and
a lock configured to hold a second lateral side of the information terminal is formed by a second side wall of the bezel cover which faces the first side wall.

5. The touch panel unit as claimed in claim 1, wherein
the bezel cover has a box shape and includes an opening through which the information terminal is inserted into the bezel cover; and
the touch panel unit further comprises a lid configured to close the opening.

6. The touch panel unit as claimed in claim 1, further comprising:
an open-box shaped housing configured to house the information terminal, wherein
grooves for slidably holding the bezel cover are formed in opposing inner surfaces of the housing; and
the information terminal is placed in a region enclosed by the housing and the bezel cover.

7. The touch panel unit as claimed in claim 1, further comprising:
an open-box shaped housing configured to house the information terminal; and
a shaft,
wherein the bezel cover is rotatably attached to a corner of the housing via the shaft.

8. The touch panel unit as claimed in claim 1, further comprising:
an open-box shaped housing configured to house the information terminal; and
a shaft disposed along a side edge of the housing,
wherein the bezel cover is attached to the housing such that the bezel cover can be opened and closed around the shaft.

9. The touch panel unit as claimed in claim 1, wherein the bezel cover includes a recess configured to house an operation pen used to operate the first touch panel.

10. The touch panel unit as claimed in claim 1, wherein the touch panel unit is configured to be supplied with power from the information terminal.

11. The touch panel unit as claimed in claim 1, wherein
the bezel cover includes an opening in a position corresponding to a position of a connector of the information terminal; and
the bezel cover includes a sliding cover configured to open and close the opening.

12. The touch panel unit as claimed in claim 1, wherein the bezel cover includes a connector configured to be connected to a connector of the information terminal.

13. The touch panel unit as claimed in claim 12, wherein the touch panel unit is configured such that the first touch panel of the touch panel unit becomes active when the connector of the information terminal and the connector of the bezel cover are connected to each other.

14. The touch panel unit as claimed in claim 1, further comprising:
a selector configured to receive a selection of one of the first touch panel of the touch panel unit and the second touch panel of the information terminal after the touch panel unit is attached to the information terminal.
